(19) United States
(12) Patent Application Publication
(10) Pub. No.: US 2026/0349722 A1
(43) Pub. Date: Nov. 5, 2026

(54) METHOD FOR GENERATING COMPUTING INSTRUCTIONS FOR NEURAL NETWORKS

(71) Applicant: Robert Bosch GmbH, Stuttgart (DE)

(72) Inventors: Sebastian Boblest, Duernau (DE); Benjamin Wagner, Friedrichshafen (DE); Duy Khoi Vo, Stuttgart (DE); Leif Sulaiman, Lund (SE); Markus Lochmann, Reutlingen (DE); Ulrik Hjort, Malmö (SE)

(21) Appl. No.: 19/552,419

(22) Filed: Feb. 27, 2026

(30) Foreign Application Priority Data
Mar. 10, 2025 (DE) 10 2025 108 855.1

(51) Int. Cl. G06F 9/30

(52) U.S. Cl. CPC G06F 9/3001

(57) ABSTRACT

A computer-implemented method for generating a computing instruction for performing at least one matrix-vector multiplication in a neural network on a computing device. When the computing instruction is executed by the computing device, the matrix-vector multiplication is performed in a neural network on the computing device. The computing instruction is generated in such a way that a number of rows in a matrix that are calculated in parallel in the matrix-vector multiplication is specified. The number of rows to be calculated in parallel is determined depending on the neural network, in particular depending on a relevant layer of the neural network, and depending on the computing device on which the matrix-vector multiplication is performed.

### CROSS REFERENCE

The present application claims the benefit under 35 U.S.C. § 119 of Germany Patent Application No. DE 10 2025 108 855.1 filed on Mar. 10, 2025, which is expressly incorporated herein by reference in its entirety.

### FIELD

The present disclosure relates to a computer-implemented method for generating a computing instruction for performing calculations, for example at least one matrix-vector multiplication, in a neural network on a computing device. When the computing instruction is executed by the computing device, the matrix-vector multiplication is performed in the neural network on the computing device.

### BACKGROUND INFORMATION

Certain functions for implementing operations in neural networks are described in the related art, such as the CMSIS-NN library, which, when performing a matrix-vector multiplication of a weight matrix by an input vector in a neural network, load elements from two rows of the weight matrix in parallel together with elements from the input vector.

### SUMMARY

One example embodiment of the present disclosure relates to a computer-implemented method for generating a computing instruction for performing at least one matrix-vector multiplication in a neural network on a computing device, wherein when the computing instruction is executed by the computing device, the matrix-vector multiplication is performed in a neural network on the computing device, characterized in that the computing instruction is generated in such a way that a number of rows in a matrix that are calculated in parallel in the matrix-vector multiplication is specified, wherein the number of rows to be calculated in parallel is determined depending on the neural network, in particular depending on a relevant layer of the neural network, and depending on the computing device on which the matrix-vector multiplication is performed.

Matrix-vector multiplications in neural networks are used in the multiplication of a weight matrix by an input vector of a layer of the neural network.

Matrix-vector multiplications are performed in different layers of a neural network, for example as a main operation of the layer. Examples thereof include matrix-vector multiplications in fully connected layers of feed-forward networks and in convolutional neural networks (CNNs), or gate matrix calculations in recurrent neural networks (RNNs), such as in LSTMs (long short-term memory) and GRUs (gated recurrent units).

It is therefore provided to generate a computing instruction individually adapted to a neural network and to a computing device. Advantageously, the number of rows to be calculated in parallel is specified in such a way that the performing of the matrix-vector multiplication can be improved. For example, as a result of a number of rows to be calculated in parallel that is individually adapted to the neural network and the computing device, a required computing time for performing the matrix-vector multiplication and/or the resources required therefor can be optimized.

The optimal number of rows to be calculated in parallel can be determined experimentally. For example, a performance of the computing instruction executed as a computer program can be measured and analyzed to determine how fast and/or efficiently the computer program runs. In this way, performance bottlenecks can be identified and then optimized through adaptations.

According to one example embodiment, it is provided that the number of rows to be calculated in parallel is determined depending on at least a first specification which characterizes the neural network.

For example, the first specification comprises a data type of the neural network, wherein the data type determines how numerical values are stored and/or processed in the neural network. Examples of such a data type of the first specification are int8, int16, float, float16, or other data types. Such data types describe a range of values and the memory size of numerical values and play a role with regard to memory management and computing power.

According to one example embodiment, it is provided that the number of rows to be calculated in parallel is determined depending on at least a second specification which characterizes the computing device.

For example, the second specification comprises an item of information about an availability of memory of the computing device, in particular an availability of registers of the computing device, and/or an item of information about an availability of a cache of the computing device. Available memory, in particular the availability of registers and/or cache of the computing device, plays an important role in processing speed and data access times, and in particular in their optimization.

According to one example embodiment, it is provided that the generation of the computing instruction comprises generating a specific function for a relevant layer, which executes a matrix-vector multiplication, of the neural network, wherein a number of rows in a matrix of the relevant layer, in particular a weight matrix, is taken into account in relation to the number of rows to be calculated in parallel.

This can advantageously prevent the computing instruction from comprising no, or as little as possible, “dead code,” i.e., unused code, for example in the form of code that is either not reached or has no effect on the execution of the computing instruction.

According to one example embodiment, it is provided that if the number of rows in the matrix is an integer multiple of the number of rows to be calculated in parallel, the computing instruction is generated in such a way that the computing instruction comprises a main block for the parallel calculation of the rows in the matrix-vector multiplication, wherein the main block comprises instructions according to which the parallel calculation of rows is carried out for the number of rows to be calculated in parallel, and wherein when the computing instruction is executed, the main block is performed repeatedly according to the number of the integer multiple, for an integer multiple greater than 1.

The computing instruction is thus generated in such a way that when the computing instruction is executed, the main block is repeated until the matrix-vector multiplication has been performed for all rows of the matrix, wherein in the main block in each case rows are calculated in parallel according to the number of rows to be calculated in parallel.

According to one example embodiment, it is provided that if the number of rows in the matrix is not an integer multiple of the number of rows to be calculated in parallel, the computing instruction is generated in such a way that when the computing instruction is executed, the matrix-vector multiplication is performed as follows:
for the case in which the number of rows in the matrix is less than the number of rows to be calculated in parallel: performing the matrix-vector multiplication for the remaining rows of the matrix, wherein the matrix-vector multiplication is performed in parallel for the remaining rows of the matrix, and
for the case in which the number of rows in the matrix is greater than the number of rows to be calculated in parallel: performing the matrix-vector multiplication according to a main block of the computing instruction, wherein the main block comprises instructions according to which the parallel calculation of rows is carried out for the number of rows to be calculated in parallel, and wherein the main block is performed at least once or multiple times until a number of remaining rows in the matrix is less than the number of rows to be calculated in parallel, and performing the matrix-vector multiplication for the remaining rows of the matrix, wherein the matrix-vector multiplication is performed in parallel for the remaining rows of the matrix.

If the number of rows in the matrix is not an integer multiple of the number of rows to be calculated in parallel and the number of rows in the matrix is less than the number of rows to be calculated in parallel, the computing instruction is thus generated in such a way that when the computing instruction is executed, the matrix-vector multiplication is performed in parallel for the rows of the matrix.

If the number of rows in the matrix is not an integer multiple of the number of rows to be calculated in parallel and the number of rows in the matrix is greater than the number of rows to be calculated in parallel, the computing instruction is thus generated in such a way that when the computing instruction is executed, the main block is repeated until a number of remaining rows in the matrix is less than the number of rows to be calculated in parallel, wherein in the main block in each case rows are calculated in parallel according to the number of rows to be calculated in parallel. For the remaining rows of the matrix, the matrix-vector multiplication is performed in parallel.

Limiting the repetition of the main block can prevent the main block from being performed for a number of rows in the matrix that is less than the number of rows to be calculated in parallel, or for a number of remaining rows in the matrix that is less than the number of rows to be calculated in parallel.

According to one example embodiment, it is provided that in order to implement access to elements of the matrix, in particular weights of the weight matrix, the elements are arranged in such a way that with the access the elements of the matrix of the rows can be accessed jointly according to the number of rows to be calculated in parallel for which the matrix-vector multiplication is performed in parallel. A memory location of the elements of the matrix is accessed for example via pointers, which typically access a relevant memory location of the elements of a row. The elements of the matrix, in particular weights of the weight matrix, can however also be arranged in such a way that a single pointer accesses the memory location of all elements of the rows for which the matrix-vector multiplication is performed in parallel. In particular, the joint access is implemented for the elements of the rows for which the matrix-vector multiplication is performed in parallel according to the main block of the computing instruction. In particular, the joint access is implemented for the elements of remaining rows of the matrix for which the matrix-vector multiplication is performed in parallel according to the computing instruction. In principle, the elements of the rows of the matrix for which the matrix-vector multiplication is performed in parallel are converted into a row vector. One dimension of the row vector results from a number of columns in the matrix and the number of rows to be calculated in parallel.

Further example embodiments relate to a computing instruction generated according to a method according to the described embodiments, wherein when the computing instruction is executed by a computing device, the computing instruction causes the computing device to perform a matrix-vector multiplication in a neural network on the computing device, wherein the matrix-vector multiplication is performed in such a way that the matrix-vector multiplication for the rows is calculated in parallel according to the specified number of rows to be calculated in parallel.

Further example embodiments relate to a computer program, wherein the computer program comprises computer-readable instructions, upon the execution of which by a computer the method according to the described embodiments runs.

Further advantages can be found in the description and the figures. Exemplary embodiments of the present disclosure are shown in the figures and explained in more detail in the following description. Here, the same reference signs in different figures in each case denote the same elements or at least elements that are comparable in terms of their function. In the description of individual figures, reference may also be made to elements from other figures.

### BRIEF DESCRIPTION OF THE DRAWINGS

FIG. 1 is a schematic overview of steps of a computer-implemented method for generating a computing instruction, according to an example embodiment.

FIG. 2 is a simplified schematic representation of a matrix,

FIG. 3 is a simplified schematic representation of another matrix.

FIG. 4 is a table that represents the runtime of a computing operation.

FIG. 5 is another table that represents the runtime of a computing operation.

### DETAILED DESCRIPTION OF EXAMPLE EMBODIMENTS

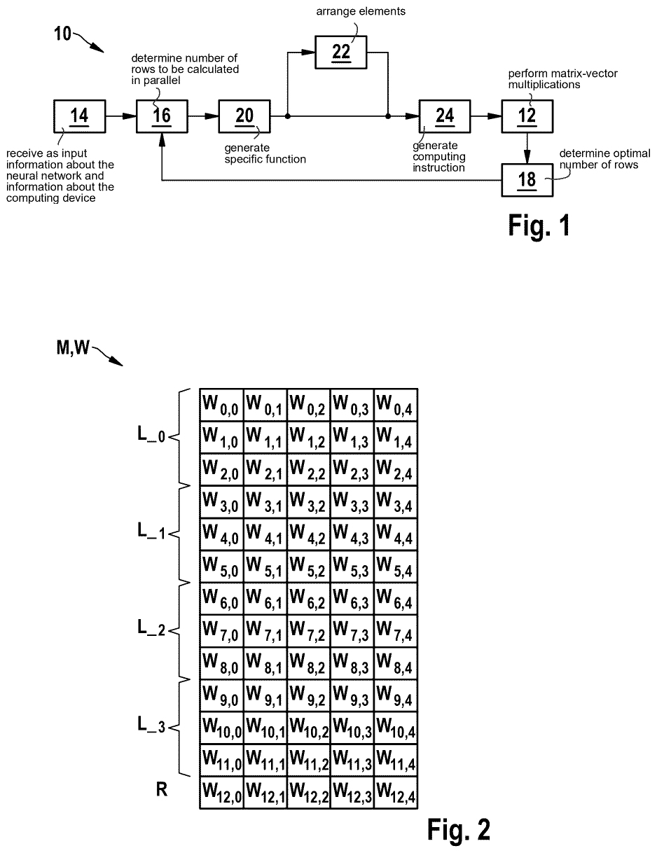

FIG. 1 is a schematic overview of steps of a computer-implemented method for generating a computing instruction. The computer-implemented method is overall denoted by the reference sign 10. The generation of the computing instruction, for example the production of code, is shown schematically in a step 24.

The computing instruction shown in FIG. 1 as an output 12 of the method 10 relates to the performing of matrix-vector multiplications in a neural network on a computing device, wherein when the computing instruction 12 is executed by the computing device, the matrix-vector multiplication is performed in a neural network on the computing device.

It is provided that the computing instruction is generated in such a way that a number of rows in a matrix that are calculated in parallel in the matrix-vector multiplication is specified, wherein the number of rows to be calculated in parallel is determined depending on the neural network, in particular depending on a relevant layer of the neural network, and depending on the computing device on which the matrix-vector multiplication is performed.

According to FIG. 1, the method 10 receives as an input 14 of the method 10 information about the neural network and information about the computing device.

The information comprises, for example, a first specification which characterizes the neural network, and/or a second specification which characterizes the computing device.

In a step 16, a number n_par of rows to be calculated in parallel is determined.

According to one embodiment, it is provided that the number n_par of rows to be calculated in parallel is determined depending on at least the first specification which characterizes the neural network.

For example, the first specification comprises a data type of the neural network, wherein the data type determines how numerical values are stored and/or processed in the neural network. Examples of such a data type of the first specification are int8, int16, float, float16, or other data types. Such data types describe data region and the memory size of numerical values and play a role with regard to memory management and computing power.

According to one embodiment, it is provided that the number n_par of rows to be calculated in parallel is determined depending on at least the second specification which characterizes the computing device.

For example, the second specification comprises an item of information about an availability of memory of the computing device, in particular an availability of registers of the computing device, and/or an item of information about an availability of a cache of the computing device. Available memory, in particular the availability of registers and/or cache of the computing device, plays an important role in processing speed and data access times, and in particular in their optimization.

The optimal number n_par of rows to be calculated in parallel can be determined experimentally, or can have been determined experimentally, either as part of the method 10 or outside the method 10; cf. step 18. For example, a performance of the computing instruction 12 executed as a computer program can be measured and analyzed to determine how fast and/or efficiently the computer program runs. In this way, performance bottlenecks can be identified and then optimized through adaptations.

According to FIG. 1, it is provided that in a step 20 a specific function is generated for a relevant layer, which executes a matrix-vector multiplication, of the neural network, wherein a number u of rows in a matrix M of the relevant layer, in particular a weight matrix W, is taken into account in relation to the number n_par of rows to be calculated in parallel.

In this way it can advantageously be achieved that the computing instruction 12 comprises no, or as little as possible, “dead code,” i.e., unused code, for example in the form of code that is either not reached or has no effect on the execution of the computing instruction.

The following procedure is used in the example in the generation of the specific function:

If the number u of rows in the matrix M, or the weight matrix W, is an integer multiple of the number n_par of rows to be calculated in parallel, the computing instruction is generated in such a way that the computing instruction comprises a main block for the parallel calculation of the rows in the matrix-vector multiplication, wherein the main block comprises instructions according to which the parallel calculation of rows is carried out for the number of rows to be calculated in parallel, and wherein when the computing instruction is executed, the main block is performed repeatedly according to the number of the integer multiple, for an integer multiple greater than 1.

In this case, the computing instruction is thus generated in such a way that when the computing instruction 12 is executed, the main block is repeatedly executed until the matrix-vector multiplication has been performed for all rows of the matrix M, or weight matrix W, wherein in the main block in each case rows are calculated in parallel according to the number n_par of rows to be calculated in parallel.

For n_par=3 and u=12, the main block is performed, e.g., four times, for example in four loops L_0, L_1, L_2 and L_3.

For n_par=5 and u=10, the main block is performed, e.g., twice, for example in two loops L_0 and L_1.

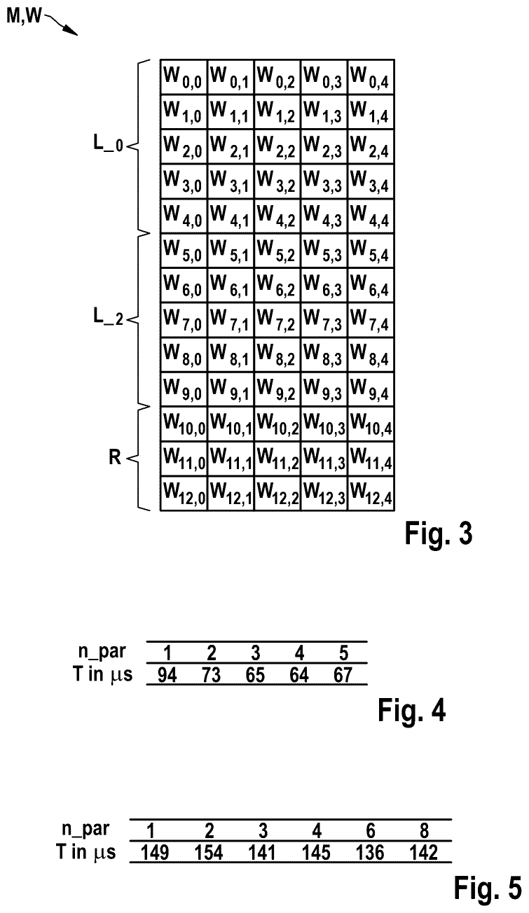

If the number u of rows in the matrix M, or weight matrix W, is not an integer multiple of the number n_par of rows to be calculated in parallel, the computing instruction is generated in such a way that when the computing instruction is executed, the matrix-vector multiplication is performed as follows:
for the case in which the number of rows in the matrix M, or weight matrix W, is less than the number of rows to be calculated in parallel, i.e., u<n_par:
performing the matrix-vector multiplication for the remaining rows of the matrix, wherein the matrix-vector multiplication is performed in parallel for the remaining rows of the matrix.
In this case, the computing instruction is thus generated in such a way that the matrix-vector multiplication is performed in parallel for the rows with the number u of rows in the matrix M, or weight matrix W.
For n_par=5 and u=4, for example, the matrix-vector multiplication is performed in parallel for the rows with the number u of rows in the matrix M, or weight matrix W.
for the case in which the number of rows in the matrix M, or weight matrix W, is greater than the number of rows to be calculated in parallel, i.e., u>n_par: performing the matrix-vector multiplication according to a main block of the computing instruction, wherein the main block comprises instructions according to which the parallel calculation of rows is carried out for the number n_par of rows to be calculated in parallel, and wherein the main block is performed at least once or multiple times until a number of remaining rows in the matrix M, or weight matrix W, is less than the number n_par of rows to be calculated in parallel, and performing the matrix-vector multiplication for the remaining rows of the matrix M, or weight matrix W, wherein the matrix-vector multiplication is performed in parallel for the remaining rows of the matrix M, or weight matrix W.
   For n_par=3 and u=13, the main block is performed, e.g., four times, for example in four loops L_0, L_1, L_2 and L_3. Subsequently, for one remaining row the matrix-vector multiplication is performed in a block R; cf. FIG. 2.
   For n_par=5 and u=13, the main block is performed, e.g., twice, for example in two loops L_0 and L_1. Subsequently, for three remaining rows the matrix-vector multiplication is performed in a block R; cf. FIG. 3. For the three remaining rows, the matrix-vector multiplication is performed in parallel in block R.

Limiting the repetition of the main block can prevent the main block from being performed for a number u of rows in the matrix M, or weight matrix W, that is less than the number n_par of rows to be calculated in parallel, or for a number of remaining rows in the matrix M, or weight matrix W, that is less than the number n_par of rows to be calculated in parallel.

The matrices M, or W, according to FIGS. 2 and 3 have dimensions m×n in this example, where m=u. In this example, matrices M, or W, comprise elements, in particular weights w_{0,0} to w_{m,n}. The weights are arranged in rows m and columns n. According to FIG. 2, the matrix M, or W, comprises in the first row the weights w_{0,0}, w_{0,1}, w_{0,2}, w_{0,3} and w_{0,4}. The weights w_{1,0}, w_{1,1}, w_{1,2}, w_{1,3}, w_{1,4} etc. are arranged in the second row of M, or W, and the weights w_{12,0}, w_{12,1}, w_{12,2}, w_{12,3}, w_{12,4} are arranged in the thirteenth column.

In order to access the elements of the matrix M, or W, corresponding memory accesses can be implemented for example in the form of pointers, which usually access a relevant memory location of the elements of a row. For example, the access can be carried out row by row, so that each row of the matrix is accessed with its own pointer.

According to one embodiment, it is provided that in order to implement access to elements of the matrix, in particular weights of the weight matrix, the elements are arranged in such a way that (cf. step 22) with the access the elements of the matrix of the rows can be accessed jointly according to the number of rows to be calculated in parallel for which the matrix-vector multiplication is performed in parallel.

The elements of the matrix, in particular weights of the weight matrix, can therefore also be arranged in such a way that a single pointer accesses the memory location of all elements of the rows for which the matrix-vector multiplication is performed in parallel. In particular, the joint access is implemented for the elements of the rows for which the matrix-vector multiplication is performed in parallel according to the main block of the computing instruction. In particular, the joint access is implemented for the elements of remaining rows of the matrix for which the matrix-vector multiplication is performed in parallel according to the computing instruction.

For example, in a matrix M, or W, according to FIG. 2, the elements can be arranged in such a way that in the first loop of the main block, in an access the elements w_{0,0}, w_{0,1}, w_{0,2}, w_{0,3}, w_{0,4}, w_{1,0}, w_{1,1}, w_{1,2}, w_{1,3}, w_{1,4}, w_{2,0}, w_{2,1}, w_{2,2}, w_{2,3}, w_{2,4}, or the memory location of the elements, are accessed, in particular by means of a single pointer. Accordingly, in the second loop the elements w_{3,0} to w_{5,4}, are jointly accessed, in the third loop the elements w_{6,0} to w_{8,4}, and in the fourth loop the elements w_{9,0} to w_{11,4}.

In principle, the elements of the rows of the matrix M, or W, for which the matrix-vector multiplication is performed in parallel are converted into a row vector. In the example of the matrix M, or W, according to FIG. 2, the row vector in the main block has the dimension 1×15, wherein the number of columns, 15, results from the number of columns, 5, of the matrix M, or W, and the number n_par=3.

Analogously, in the example, in a matrix M, or W, according to FIG. 3, the elements can be arranged in such a way that in the first loop of the main block, in an access the elements w_{0,0}, w_{0,1}, w_{0,2}, w_{0,3}, w_{0,4}, w_{1,0}, w_{1,1}, w_{1,2}, w_{1,3}, w_{1,4}, w_{2,0}, w_{2,1}, w_{2,2}, w_{2,3}, w_{2,4}, w_{3,0}, w_{3,1}, w_{3,2}, w_{3,3}, w_{3,4}, w_{4,0}, w_{4,1}, w_{4,2}, w_{4,3}, w_{4,4}, or the memory location of the elements, are accessed, in particular by means of a single pointer. Accordingly, in the second loop, the elements w_{5,0} to w_{9,4} are jointly accessed. For the three remaining rows for which the matrix-vector multiplication is performed in parallel in block R, the elements w_{10,0} to w_{12,4} can also be jointly accessed.

In principle, the elements of the rows of the matrix M, or W, for which the matrix-vector multiplication is performed in parallel are converted into a row vector. In the example of the matrix M, or W, according to FIG. 3, the row vector in the main block has the dimension 1×25, wherein the number of columns, 25, results from the number of columns, 5, of matrix M, or W, and the number n_par=5. In the block R, the row vector has the dimension 1×15.

The table in FIG. 4 shows an overview of runtimes T of a matrix-vector multiplication for different values for the number n_par of rows to be calculated in parallel for a fully connected layer of a neural network, with data type float, on a Cortex-M7 (280 MHz) computing device, with a matrix having the dimension 63×63. For n_par=4, the runtime is comparatively the shortest.

The table in FIG. 5 shows an overview of runtimes T of a matrix-vector multiplication for different values for the number n_par of rows to be calculated in parallel for a fully connected layer of a neural network, with data type int8, on a Cortex-M7 (280 MHz) computing device, with a matrix having the dimension 127×127. For n_par=6, the runtime is comparatively the shortest. Compared to a standard implementation in CMSIS-NN with n_par=2, this represents a performance increase of 12%.

What is claimed is:

1. A computer-implemented method for generating a computing instruction for performing at least one matrix-vector multiplication in a neural network on a computing device, wherein when the computing instruction is executed by the computing device, the matrix-vector multiplication is performed in a neural network on the computing device, the method comprising the following steps:
generating the computing instruction in such a way that a number of rows in a matrix that are calculated in parallel in the matrix-vector multiplication is specified, wherein the number of rows to be calculated in parallel is determined depending on the neural network, and depending on the computing device on which the matrix-vector multiplication is performed.

2. The method according to claim 1, wherein the number of rows to be calculated in parallel is determined depending on a relevant layer of the neural network, and depending on the computing device on which the matrix-vector multiplication is performed

3. The method according to claim 1, wherein the number of rows to be calculated in parallel is determined depending on at least a first specification which characterizes the neural network.

4. The method according to claim 3, wherein the first specification includes a data type of the neural network, wherein the data type determines at least one of: (i) how numerical values are stored, or (ii) how the numerical values are processed in the neural network.

5. The method according to claim 3, wherein the number of rows to be calculated in parallel is determined depending on at least a second specification which characterizes the computing device.

6. The method according to claim 5, wherein the second specification includes an item of information about at least one of: (i) an availability of memory of the computing device including an availabilty of registers of the computing device, or (ii) an item of information about an availability of a cache of the computing device.

7. The method according to claim 1, wherein the generation of the computing instruction includes generating a specific function for a relevant layer, which executes the matrix-vector multiplication, of the neural network, wherein a number of rows in the matrix is taken into account in relation to the number of rows to be calculated in parallel, wherein the matrix is a matrix of the relevant layer.

8. The method according to claim 7, wherien the matrix of the relevant layer is a weight matrix of the relevant layer.

9. The method according to claim 7, wherein when the number of rows in the matrix is an integer multiple of the number of rows to be calculated in parallel, the computing instruction is generated in such a way that the computing instruction includes a main block for the parallel calculation of the rows in the matrix-vector multiplication, wherein the main block includes instructions according to which the parallel calculation of rows is carried out for the number of rows to be calculated in parallel, and wherein when the computing instruction is executed, the main block is performed repeatedly according to the number of the integer multiple, wherein the integer multiple is greater than 1.

10. The method according to claim 9, wherein when the number of rows in the matrix is not an integer multiple of the number of rows to be calculated in parallel, the computing instruction is generated in such a way that when the computing instruction is executed, the matrix-vector multiplication is performed as follows:
when the number of rows in the matrix is less than the number of rows to be calculated in parallel: performing the matrix-vector multiplication for the rows of the matrix, wherein the matrix-vector multiplication is performed in parallel for the rows of the matrix, and
when the number of rows in the matrix is greater than the number of rows to be calculated in parallel: performing the matrix-vector multiplication according to a main block of the computing instruction, wherein the main block includes instructions according to which the parallel calculation of rows is carried out for the number of rows to be calculated in parallel, and wherein the main block is performed at least once or multiple times until a number of remaining rows in the matrix not processed by the main block is less than the number of rows to be calculated in parallel, and performing the matrix-vector multiplication for the remaining rows of the matrix, wherein the matrix-vector multiplication is performed in parallel for the remaining rows of the matrix.

11. The method according to claim 1, wherein, to implement access to elements of the matrix, the elements are arranged in such a way that with the access the elements of the matrix of the rows can be accessed jointly according to the number of rows to be calculated in parallel for which the matrix-vector multiplication is performed in parallel.

12. The method according to claim 1, further comprising:
executing the computing instruction on the computing device to perform the matrix-vector multiplication in the neural network on the computing device, wherein the matrix-vector multiplication is performed in such a way that the matrix-vector multiplication for the rows is calculated in parallel according to the specified number of rows to be calculated in parallel.

13. A non-transitory computer-readable medium on which is stored a computer program including computer-readable instructions for generating a computing instruction for performing at least one matrix-vector multiplication in a neural network on a computing device, wherein when the computing instruction is executed by the computing device, the matrix-vector multiplication is performed in a neural network on the computing device, the computer-readable instructions, when executed by a computer, causing the computer to perform the following steps:
generating the computing instruction in such a way that a number of rows in a matrix that are calculated in parallel in the matrix-vector multiplication is specified, wherein the number of rows to be calculated in parallel is determined depending on the neural network, and depending on the computing device on which the matrix-vector multiplication is performed.
